(19) United States
(12) Patent Application Publication
(10) Pub. No.: US 2020/0202355 A1
(43) Pub. Date: Jun. 25, 2020

(54) STORAGE AND EXECUTION OF SMART CONTRACTS IN BLOCKCHAINS

(71) Applicant: Alibaba Group Holding Limited, George Town (KY)

(72) Inventor: Zhiyuan Feng, Hangzhou (CN)

(73) Assignee: Alibaba Group Holding Limited, George Town (KY)

(21) Appl. No.: 16/804,775

(22) Filed: Feb. 28, 2020

Related U.S. Application Data
(63) Continuation of application No. PCT/CN2020/071088, filed on Jan. 9, 2020.

(30) Foreign Application Priority Data
Apr. 19, 2019 (CN) 201910317303.9

(51) Int. Cl. G06Q 20/40; H04L 9/06

(52) U.S. Cl. CPC G06Q 20/405; H04L 9/0643; H04L 9/0637

(57) ABSTRACT

This disclosure relates to storing and executing a smart contract in a blockchain. In one aspect, a method includes receiving a transaction request to conduct a transaction for storing a target smart contract in the blockchain. The target smart contract includes multiple logical methods. A query is made whether the target smart contract includes a first logical method that is the same as a second logical method in a stored smart contract that is stored in the blockchain. In response to determining that the target smart contract includes the first logical method that is the same as the second logical method in the stored smart contract, each logical method of the multiple logical methods that is not the same as a logical method previously stored in the blockchain and a mapping relationship between the first logical method and the second logical method is stored in the blockchain.

### CROSS-REFERENCE TO RELATED APPLICATIONS

This application is a continuation of PCT Application No. PCT/CN2020/071088, filed on Jan. 9, 2020, which claims priority to Chinese Patent Application No. 201910317303.9, filed on Apr. 19, 2019, and each application is hereby incorporated by reference in its entirety.

### TECHNICAL FIELD

Implementations of the present disclosure relate to the field of blockchain technologies, and in particular, to storing and executing a smart contract in a blockchain.

### BACKGROUND

Blockchain technology, also referred to as a distributed ledger technology, is an emerging technology in which several computing devices jointly participate in “accounting” and jointly maintain a complete distributed database. Due to its features of decentralization, openness, transparency, participation in database recording by each computing device, and fast data synchronization between computing devices, blockchain technology has been widely used in many fields.

### SUMMARY

Implementations of the present specification provide methods and apparatuses for storing and executing a smart contract in a blockchain, and electronic devices.

According to a first aspect of the implementations of the present specification, a method for storing a smart contract in a blockchain is provided, where the method includes the following: receiving a transaction for storing a target smart contract; in response to the transaction, invoking storage logic of the smart contract published to the blockchain; querying whether the target smart contract has a same logical method as a stored smart contract; and if yes, storing, in the blockchain, another logical method except the same logical method in the target smart contract, and a mapping relationship between the logical methods that are the same in the target smart contract and the stored smart contract.

Optionally, the querying whether the target smart contract has a same logical method as a stored smart contract includes the following: calculating a unique identifier of each logical method in the target smart contract; and if the unique identifier is consistent with a unique identifier of the logical method stored in the blockchain, determining that the logical method corresponding to the consistent unique identifier is the same as the logical method in the stored smart contract.

Optionally, the storing, in the blockchain, a mapping relationship between the logical methods that are the same in the target smart contract and the stored smart contract includes the following: converting the same logical method in the target smart contract into a unique identifier of the same logical method, and storing the unique identifier in the blockchain.

Optionally, the unique identifier includes a unique path or a digital digest; the unique path includes a file name and a method name of the logical method; and the digital digest includes a hash value that is obtained through hash calculation on the logical method.

Optionally, the blockchain includes a consortium blockchain, a public blockchain, or a private blockchain.

According to a second aspect of the implementations of the present specification, a method for executing a smart contract in a blockchain is provided, where the smart contract is stored in the blockchain according to any method for storing a smart contract in a blockchain described above, and the method includes the following: receiving a transaction for executing a target service; in response to the transaction, querying a target smart contract that is needed to execute the target service in the blockchain; obtaining, based on a mapping relationship between logical methods that are the same in the target smart contract and a stored smart contract, the same logical method and another logical method except the same logical method in the target smart contract; and assembling the another logical method and the same logical method into a complete contract logical method in an instantiated virtual machine, and executing the contract logical method.

Optionally, the obtaining, based on a mapping relationship between logical methods that are the same in the target smart contract and a stored smart contract, the same logical method includes the following: obtaining a unique identifier stored in the target smart contract; and if the unique identifier is the same as a unique identifier of a logical method in the stored smart contract, obtaining the logical method in the stored smart contract.

Optionally, the unique identifier includes a unique path or a digital digest; the unique path includes a file name and a method name of the logical method; and the digital digest includes a hash value that is obtained through hash calculation on the logical method.

Optionally, the method further includes the following: if execution of the target smart contract needs state data, obtaining the state data from a data field of the target smart contract; and the assembling the another logical method and the same logical method into a complete contract logical method in an instantiated virtual machine, and executing the contract logical method includes the following: assembling the another logical method and the same logical method into the complete contract logical method in the instantiated virtual machine, and loading the state data to the contract logical method for execution.

Optionally, the method further includes the following: instantiating a virtual machine when a node device in the blockchain starts, wherein the virtual machine is configured to execute any smart contract in the node device.

Optionally, the blockchain includes a consortium blockchain, a public blockchain, or a private blockchain.

According to a third aspect of the implementations of the present specification, an apparatus for storing a smart contract in a blockchain is provided, where the apparatus includes the following: a receiving unit, configured to receive a transaction for storing a target smart contract; a responding unit, configured to: in response to the transaction, invoke storage logic of the smart contract published to the blockchain; a query unit, configured to query whether the target smart contract has a same logical method as a stored smart contract; and a storage unit, configured to: if yes, store, in the blockchain, another logical method except the same logical method in the target smart contract, and a mapping relationship between the logical methods that are the same in the target smart contract and the stored smart contract.

Optionally, the query unit includes the following: a calculation subunit, configured to calculate a unique identifier of each logical method in the target smart contract; and a determining unit, configured to: if the unique identifier is consistent with a unique identifier of the logical method stored in the blockchain, determine that the logical method corresponding to the consistent unique identifier is the same as the logical method in the stored smart contract.

Optionally, the storage unit is configured to store, in the blockchain, a mapping relationship between the logical methods that are the same in the target smart contract and the stored smart contract, including the following: converting the same logical method in the target smart contract into a unique identifier of the same logical method, and storing the unique identifier in the blockchain.

Optionally, the unique identifier includes a unique path or a digital digest; the unique path includes a file name and a method name of the logical method; and the digital digest includes a hash value that is obtained through hash calculation on the logical method.

Optionally, the blockchain includes a consortium blockchain, a public blockchain, or a private blockchain.

According to a fourth aspect of the implementations of the present specification, an apparatus for executing a smart contract in a blockchain is provided, where the smart contract is stored in the blockchain according to any method for storing a smart contract in a blockchain described above, and the apparatus includes the following: a receiving unit, configured to receive a transaction for executing a target service; a responding unit, configured to: in response to the transaction, query a target smart contract that is needed to execute the target service in the blockchain; an acquisition unit, configured to obtain, based on a mapping relationship between logical methods that are the same in the target smart contract and a stored smart contract, the same logical method and another logical method except the same logical method in the target smart contract; and an execution unit, configured to assemble the another logical method and the same logical method into a complete contract logical method in an instantiated virtual machine, and execute the contract logical method.

Optionally, the acquisition unit is configured to obtain, based on a mapping relationship between logical methods that are the same in the target smart contract and a stored smart contract, the same logical method, including the following: a first acquisition subunit, configured to obtain a unique identifier stored in the target smart contract; and a second acquisition subunit, configured to: if the unique identifier is the same as a unique identifier of a logical method in the stored smart contract, obtain the logical method in the stored smart contract.

Optionally, the unique identifier includes a unique path or a digital digest; the unique path includes a file name and a method name of the logical method; and the digital digest includes a hash value that is obtained through hash calculation on the logical method.

Optionally, the apparatus further includes the following: a state data acquisition subunit, configured to: if execution of the target smart contract needs state data, obtain the state data from a data field of the target smart contract; and the execution unit is configured to: assemble the another logical method and the same logical method into the complete contract logical method in the instantiated virtual machine, and load the state data to the contract logical method for execution.

Optionally, the apparatus further includes the following: an instantiation unit, configured to instantiate a virtual machine when a node device in the blockchain starts, where the virtual machine is configured to execute any smart contract in the node device.

Optionally, the blockchain includes a consortium blockchain, a public blockchain, or a private blockchain.

According to a fifth aspect of the implementations of the present specification, an electronic device is provided, including the following: a processor; and a memory, configured to store a processor executable instruction, where the processor is configured to perform any method for storing a smart contract in a blockchain described above.

According to a sixth aspect of the implementations of the present specification, an electronic device is provided, including the following: a processor; and a memory, configured to store a processor executable instruction, where the processor is configured to perform any method for executing a smart contract in a blockchain described above.

The implementations of the present specification provide solutions for storing and executing a smart contract in a blockchain. First, the contract logical method and the state data that are needed to execute a smart contract are separated so that the contract logical method is no longer restricted by the data storage association. Then, the logical methods that are the same in different smart contracts are stored only once, so that the same smart contract does not need to be stored multiple times. As such, resources needed to store smart contracts are reduced. In the process of executing a smart contract, the same logical method is obtained based on the mapping relationship between the logical methods that are the same in the target smart contract and the stored smart contract, thereby restoring complete code of the target smart contract. In addition, due to separation of the contract logical method and the state data, each node device only needs to instantiate one virtual machine and can execute all smart contracts by using one virtual machine, thereby reducing resources needed to instantiate a virtual machine.

### BRIEF DESCRIPTION OF DRAWINGS

FIG. 1 is a schematic diagram of storing a smart contract in a conventional blockchain;

FIG. 2 is a flowchart illustrating a method for storing a smart contract in a blockchain, according to an implementation of the present specification;

FIG. 3 is a schematic diagram of storing a smart contract in a blockchain, according to the present specification;

FIG. 4 is a schematic diagram of executing a smart contract in a conventional blockchain;

FIG. 5 is a flowchart illustrating a method for executing a smart contract in a blockchain, according to an implementation of the present specification;

FIG. 6 is a schematic diagram of executing a smart contract in a blockchain, according to the present specification;

FIG. 7 is a diagram of a hardware structure of a storage apparatus in a blockchain, according to an implementation of the present specification;

FIG. 8 illustrates a module of a storage apparatus in a blockchain, according to an implementation of the present specification;

FIG. 9 is a diagram of a hardware structure of an execution apparatus in a blockchain, according to an implementation of the present specification; and

FIG. 10 illustrates a module of an execution apparatus in a blockchain, according to an implementation of the present specification.

### DESCRIPTION OF IMPLEMENTATIONS

Example implementations are described in detail here, and examples of the example implementations are presented in the accompanying drawings. When the following description relates to the accompanying drawings, unless specified otherwise, same numbers in different accompanying drawings represent same or similar elements. Implementations described in the following example implementations do not represent all implementations consistent with the present specification. On the contrary, the implementations are only examples of apparatuses and methods that are described in the appended claims in detail and consistent with some aspects of the present specification.

The terms used in the present specification are merely for illustrating specific implementations, and are not intended to limit the present specification. The terms “a” and “the” of singular forms used in the present specification and the appended claims are also intended to include plural forms, unless otherwise specified in the context clearly. It should be further understood that the term “and/or” used in the present specification indicates and includes any or all possible combinations of one or more associated listed items.

It should be understood that although terms “first”, “second”, “third”, etc. may be used in the present specification to describe various types of information, the information should not be limited by these terms. These terms are only used to differentiate between information of the same type. For example, without departing from the scope of the present specification, first information can also be referred to as second information, and similarly, the second information can also be referred to as the first information. Depending on the context, for example, the word “if” used here can be explained as “while”, “when”, or “in response to determining”.

A smart contract is a computer protocol that can be deployed in a blockchain to propagate, verify, or execute a contract by using an informatization method. A corresponding operation can be implemented by declaring service logic in a smart contract. The smart contract allows performing trusted transactions without participation of a third party. These transactions are traceable and irreversible. The smart contract method can provide higher security than a conventional contract method, and reduce other contract-related transaction costs.

In a conventional blockchain system, on the one hand, in response to a created smart contract, even if the smart contract has been created and published to the blockchain for storage by another requester, the smart contract still needs to be stored again. As a result, storage resources are wasted.

On the other hand, when a node device executes different smart contracts, one virtual machine needs to be instantiated for each smart contract. As a result, computing resources are wasted, and as logic of the smart contract becomes more complex, the waste is incremented.

The following describes a design for a smart contract in a conventional blockchain to further understand the reasons for the above-described problems.

In the design for the smart contract in the conventional blockchain, method logic (or service logic) of each smart contract is written by the contract publisher depending on his/her own service demand. Because the smart contract is published by an external contract publisher, an exception of operation logic of the smart contract due to the writer's negligence may occur. After the smart contract is published to the blockchain, the smart contract can be used by all node devices in the blockchain. To prevent an abnormal smart contract from causing loss to the calling party, each smart contract can be executed only in its closed environment.

The following describes universal method logic in the smart contract in the present specification.

With continuous development of blockchain technologies, the blockchain has been used in different fields and different scenarios. Generally, in the same field, especially in the same service scenario, service processes have specific universality, so there is universal method logic. Even in different fields and different service scenarios, there is interchangeably universal method logic.

For example, method logic at the programming level can be universal, and the logic is referred to as a universal logical method in the present specification, for example, an encryption signature algorithm, data parsing, a workflow, state storage, etc.

Companies having the same service also have the same method logic. The method logic is referred to as a service logical method in the present specification. For example, two tourism companies usually have universal service logic for the tourism services, such as buying flight tickets and train tickets, booking hotels, etc.

The universal method logic can come from a smart contract platform, an authoritative organization, an active open-source enthusiast, etc. Good methods will be recognized and actively adopted. As services are constantly mature and universal, underlying methods are constantly improved and optimized. Depending on the previous description, development efficiency and performance of a smart contract can be enhanced, and robustness and stability of the smart contract can be more guaranteed.

In addition, the smart contract in the conventional blockchain has limitations, and the calling party can only implement a part of the core service logic in the smart contract. The reasons are that a risk is very high, and a blockchain platform has limitations. Whether in terms of performance or scalability, execution of the smart contract on the blockchain has various constraints.

In some smart contracts, because of differences in service processes and the like, there are some differences in invoking upper-layer logic, and the underlying logic can be the same. However, different or even the same smart contracts need to be deployed for different services. Each smart contract will be stored with multiple copies on all blockchain nodes. When smart contracts are executed, each smart contract needs to be instantiated and executed in a unique, completely closed virtual machine. It causes a waste of both storage resources and computing resources of a server.

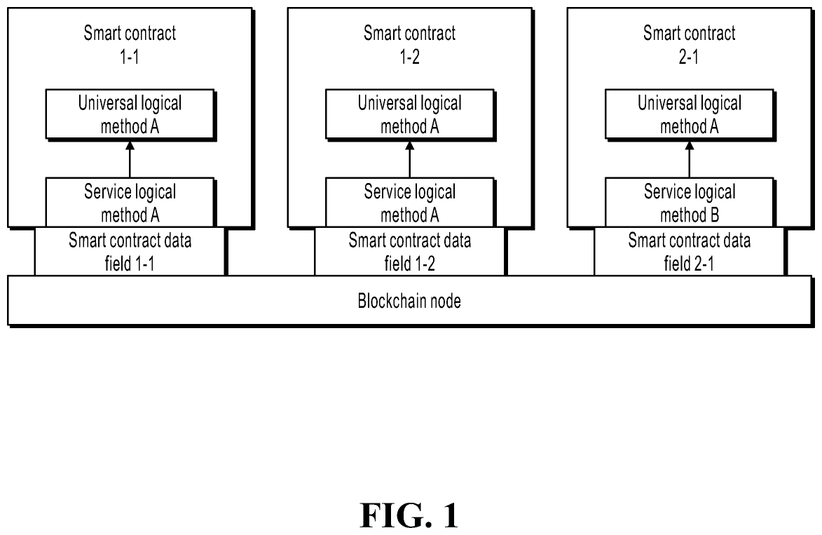

FIG. 1 is a schematic diagram of storing a smart contract in a conventional blockchain.

In FIG. 1, the blockchain stores smart contract 1-1, smart contract 1-2, and smart contract 2-1.

Smart contract 1-1 and smart contract 1-2 are the same smart contracts published by different contract publishers. Smart contract 2-1 is different from smart contract 1-1 and smart contract 1-2.

As shown in FIG. 1, smart contract 1-1 and smart contract 1-2 have the same service logical method A and the same universal logical method A.

Smart contract 2-1 and smart contract 1-1 or 1-2 have the same universal logical method A and different service logical methods B.

Although these three smart contracts have the same universal logical method A, and smart contract 1-1 and smart contract 1-2 have the same service logical method A, all the smart contracts are still independent of each other, as shown in FIG. 1. Although the universal logical method A is identical in the three contracts, the universal logical method A still needs to be stored with three copies. Although the service logical method A is identical in two contracts, the service logical method A still needs to be stored with two copies.

On the other hand, the logical method of each smart contract is associated with the corresponding data field, that is, the logical method and the data field are strongly coupled and strongly associated. For example, smart contract 1-1 corresponds to unique data field 1-1; smart contract 1-2 corresponds to unique data field 1-2; smart contract 2-1 corresponds to unique data field 2-1. The data field is used to store state data needed to execute the smart contract.

It is worthwhile to note that, the previous description is intended only for the smart contracts stored in one node device in the blockchain, and the same is true for the smart contracts stored in other node devices in the blockchain. Therefore, each node device needs to store the same logic code repeatedly, causing a waste of storage resources.

To alleviate the above-described problems about the smart contract in the conventional blockchain, the present specification provides solutions for storing and executing a smart contract in a blockchain. The waste of storage and computing resources is reduced at root. In addition, the smart contract can be executed more stably, and the logical method tends to be standardized.

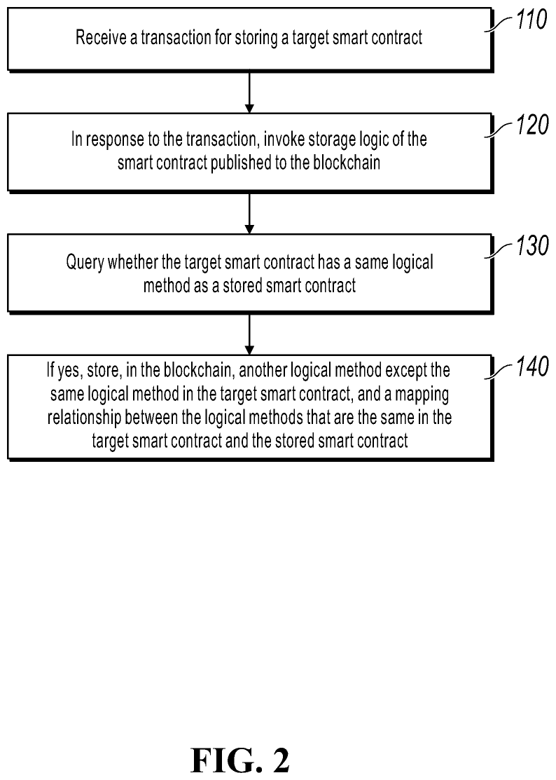

FIG. 2 is a flowchart illustrating a method for storing a smart contract in a blockchain, according to an implementation of the present specification. The method is applied to any node device in the blockchain. The method includes the following steps:

Step 110: Receive a transaction for storing a target smart contract.

Step 120: In response to the transaction, invoke storage logic of the smart contract published to the blockchain.

Step 130: Query whether the target smart contract has a same logical method as a stored smart contract.

Step 140: If yes, store, in the blockchain, another logical method except the same logical method in the target smart contract, and a mapping relationship between the logical methods that are the same in the target smart contract and the stored smart contract.

The blockchains described in the present specification can include a private blockchain, a public blockchain, a consortium blockchain, etc., which is not specially limited in the present specification. Node devices can be added to the blockchain without limitation, and all node devices can synchronize one system time to ensure the timeliness of smart contract execution.

It is worthwhile to note that, the transaction described in the present specification is a piece of data that is created by a client of the blockchain, and needs to be eventually published to a data storage system of the blockchain.

Transactions in the blockchain are generally classified into transactions in a narrow sense and transactions in a broad sense. A transaction in a narrow sense refers to a value transfer that is published by a user to the blockchain. For example, in a conventional bitcoin blockchain network, a transaction can be a funds transfer initiated by a user in the blockchain. A transaction in a broad sense refers to a piece of service data with a service intent that is published by a user to the blockchain. For example, an operator can build a consortium blockchain depending on an actual service demand, and with the help of the consortium blockchain, deploy some other types of online services (such as a query service, an invoking service, etc.) that are unrelated to value transfer. In such consortium blockchain, a transaction can be a service message or service request with a service intent that is published by the user in the consortium blockchain.

The above-mentioned client can include any type of upper-layer application that uses underlying service data stored in the blockchain as data support to implement a specific service function.

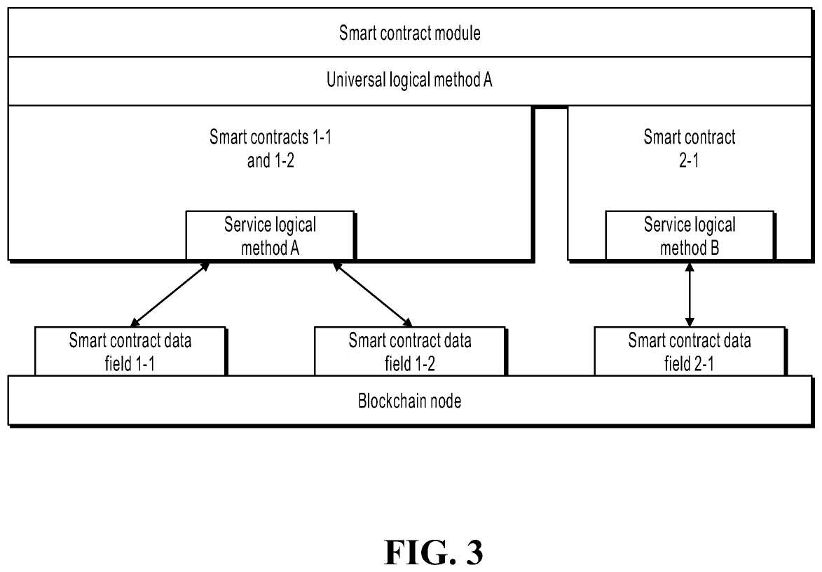

FIG. 3 is a schematic diagram of storing a smart contract in a blockchain, according to the present specification.

In FIG. 3, a smart contract can be separated as an independent smart contract module. In addition, state data and contract logic of the smart contract are separated, that is, a logical method and a data field of each smart contract are decoupled. As such, the same smart contract no longer needs to be instantiated and stored multiple times.

In the previous schematic diagram of storing the smart contract in the conventional blockchain shown in FIG. 1, smart contract 1-1 has the service logical method A and the universal logical method A.

Smart contract 1-2 has the service logical method A and the universal logical method A.

Smart contract 2-1 has the service logical method B and the universal logical method A.

FIG. 3 is also targeted at storage of these three smart contracts. It can be seen that, because smart contracts 1-1, 1-2, and 2-1 have the same universal logical method A, the universal logical method A needs to be stored only once, that is, smart contracts 1-1, 1-2, and 2-1 share the universal logical method A.

Because smart contracts 1-1 and 1-2 have the same service logical method A, the service logical method A also needs to be stored only once, that is, smart contracts 1-1 and 1-2 share the service logical method A.

In addition, due to separation of the logical method and the data field, the same service logical method A needs to separately correspond to the data fields of smart contracts 1-1 and 1-2.

It is worthwhile to note that, the universal logical method in each smart contract can be moved down to a lower layer, so that developers only need to assemble these universal logical methods based on the service logic to develop smart contracts. In addition, the developers can share more universal logical methods (optimization of existing logical methods, service logic optimization and creation, bug modification, etc.) of the platform for invoking by themselves and others.

In an implementation, the querying whether the target smart contract has a same logical method as a stored smart contract in step 130 includes the following: calculating a unique identifier of each logical method in the target smart contract; and if the unique identifier is consistent with a unique identifier of the logical method stored in the blockchain, determining that the logical method corresponding to the consistent unique identifier is the same as the logical method in the stored smart contract.

The unique identifier includes a unique path or a digital digest.

The unique path includes a file name and a method name of the logical method.

The digital digest includes a hash value that is obtained through hash calculation on the logical method.

It is worthwhile to note that, the unique path and the digital digest are merely some examples of the unique identifier. The unique identifier can also be any other content having uniqueness.

In practice, the logical method is actually a series of code used to implement the running logic, and querying the same code consumes many computing resources. However, after the logical method is converted into the digital digest or the unique path, because the content of the digital digest or the unique path is far less than the content of the code, query efficiency will be improved and the consumed computing resources will be reduced.

In an implementation, the storing, in the blockchain, a mapping relationship between the logical methods that are the same in the target smart contract and the stored smart contract in step 140 includes the following: converting the same logical method in the target smart contract into a unique identifier (for example, a digital digest or a unique path) of the same logical method, and storing the unique identifier in the blockchain.

The digital digest is used as an example for description in the following. A certain target smart contract includes logical method A, logical method B, and logical method C, and is denoted as a target smart contract {A, B, C}.

Assume that logical method A is the same as logical method A of smart contract 1 stored in the blockchain. Logical method B is the same as logical method B of smart contract 2 stored in the blockchain. Logical method C is different from all logical methods stored in the blockchain.

Then, when the target smart contract {A, B, C} is stored, the code of logical method A is converted as a whole into a digital digest of logical method A, and is denoted as hash (A).

The code of logical method B is converted as a whole into a digital digest of logical method B, and is denoted as hash (B).

As such, the target smart contract finally stored in the blockchain is actually {hash (A), hash (B), C}, where logical methods A and B are both digital digests, and only logical method C is the code itself. The hash (A) and the hash (B) are the mapping relationships between the target smart contract and the same logical method stored.

Based on the previous solution for storing a smart contract in a blockchain, first, the contract logical method and the state data that are needed to execute a smart contract are separated so that the contract logical method is no longer restricted by the data storage association. Then, the logical methods that are the same in different smart contracts are stored only once so that the same smart contract does not need to be stored multiple times. As such, resources needed to store smart contracts are reduced.

On the basis of storing smart contracts, the present specification further provides an implementation of executing a smart contract.

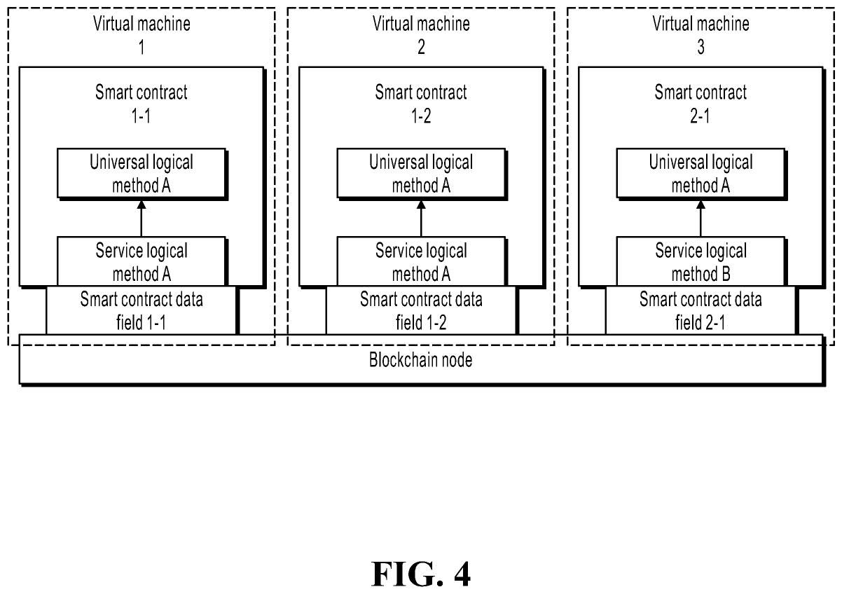

Firstly, disadvantages of the conventional blockchain are described by using the schematic diagram of executing a smart contract in the conventional blockchain shown in FIG. 4 (corresponding to the solution for storing a smart contract in the conventional blockchain shown in FIG. 1).

In FIG. 4, the logical method and the data field of the smart contract in the conventional blockchain are strongly coupled and strongly associated. For example, smart contract 1-1 corresponds to unique data field 1-1; smart contract 1-2 corresponds to unique data field 1-2; smart contract 2-1 corresponds to unique data field 2-1. The data field is used to store state data needed to execute the smart contract. Therefore, one virtual machine needs to be instantiated for executing each smart contract. Then, the logical method and the state data of the smart contract are executed in the corresponding virtual machine. Resources (memory resources and computing resources) of a node device are limited. As smart contracts of the node device constantly increase, resources consumed by the virtual machine also constantly increase, definitely causing a waste of resources.

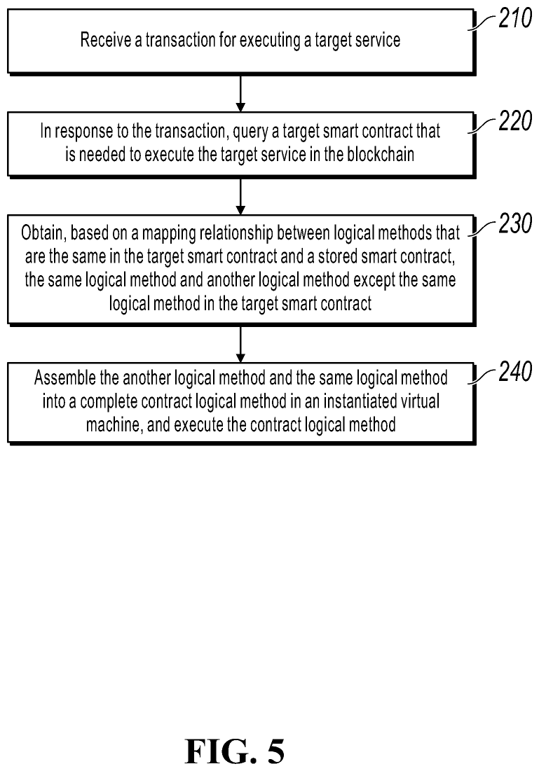

To alleviate the above-described problems, references can be made to FIG. 5. FIG. 5 is a flowchart illustrating a method for executing a smart contract in a blockchain, according to an implementation of the present specification. The method is applied to a node device in the blockchain. The smart contract is stored in the blockchain based on the method for storing a smart contract in a blockchain described above. The method includes the following steps:

Step 210: Receive a transaction for executing a target service.

Step 220: In response to the transaction, query a target smart contract that is needed to execute the target service in the blockchain.

Step 230: Obtain, based on a mapping relationship between logical methods that are the same in the target smart contract and a stored smart contract, the same logical method and another logical method except the same logical method in the target smart contract.

Step 240: Assemble the another logical method and the same logical method into a complete contract logical method in an instantiated virtual machine, and execute the contract logical method.

The blockchains described in the present specification can include a private blockchain, a public blockchain, a consortium blockchain, etc., which is not specially limited in the present specification. Node devices can be added to the blockchain without limitation, and all node devices can synchronize one system time to ensure the timeliness of smart contract execution.

It is worthwhile to note that, the transaction described in the present specification is a piece of data that is created by a client of the blockchain, and needs to be eventually published to a data storage system of the blockchain.

Transactions in the blockchain are generally classified into transactions in a narrow sense and transactions in a broad sense. A transaction in a narrow sense refers to a value transfer that is published by a user to the blockchain. For example, in a conventional bitcoin blockchain network, a transaction can be a funds transfer initiated by a user in the blockchain. A transaction in a broad sense refers to a piece of service data with a service intent that is published by a user to the blockchain. For example, an operator can build a consortium blockchain depending on an actual service demand, and with the help of the consortium blockchain, deploy some other types of online services (such as a query service, an invoking service, etc.) that are unrelated to value transfer. In such consortium blockchain, a transaction can be a service message or service request with a service intent that is published by the user in the consortium blockchain.

The above-mentioned client can include any type of upper-layer application that uses underlying service data stored in the blockchain as data support to implement a specific service function.

In an implementation, the method further includes the following: instantiating a virtual machine when a node device in the blockchain starts, where the virtual machine is configured to execute any smart contract in the node device.

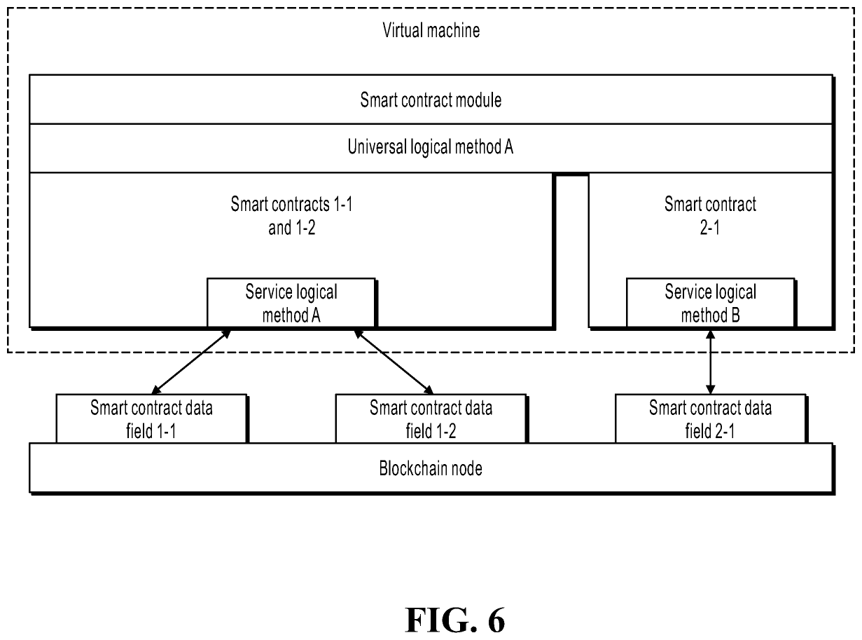

FIG. 6 is a schematic diagram of executing a smart contract in a blockchain, according to the present specification (corresponding to the solution for storing a smart contract in a blockchain, according to the present specification, as shown in FIG. 3).

As described in FIG. 3, state data and contract logic of the smart contract are separated, that is, a logical method and a data field of each smart contract are decoupled. In FIG. 6, only one virtual machine needs to be instantiated for each node device. Different smart contracts serve as different service interfaces for the virtual machine to provide services to the outside. It can be seen from comparison with FIG. 4 that, the number of instantiated virtual machines, the number of loaded smart contracts, the number of loaded universal logical methods, etc. are minimized.

In an implementation, the obtaining, based on a mapping relationship between logical methods that are the same in the target smart contract and a stored smart contract, the same logical method in step 230 includes the following: obtaining a unique identifier stored in the target smart contract; and if the unique identifier is the same as a unique identifier of a logical method in the stored smart contract, obtaining the logical method in the stored smart contract.

The unique identifier includes a unique path or a digital digest.

The unique path includes a file name and a method name of the logical method.

The digital digest includes a hash value that is obtained through hash calculation on the logical method.

The previous example of storing a smart contract is still used. The target smart contract {A, B, C} finally stored in the blockchain is actually the target smart contract {hash (A), hash (B), C}.

In the present implementation, assume that the target smart contract needed to execute the target service is also {A, B, C}. The content of the target smart contract stored in the blockchain is {hash (A), hash (B), C}, where only logical method C is code, and digital digests are actually stored for logical methods A and B. In such case, code content corresponding to the two digital digests need to be obtained.

It can be seen from the previous storage process that, each digital digest actually corresponds to a logical method in another smart contract stored in the blockchain. Therefore, original code content of hash (A) and hash (B) can be restored only by querying whether the digital digest of each logical method in each stored smart contract is consistent with hash (A) and hash (B).

It can be seen from the example content of the above-described smart contract storage that, logical method A of smart contract 1 is actually the same as logical method A of the target smart contract. Therefore, the digital digest of logical method A of smart contract 1 is definitely the same as hash (A). As such, it can be determined that the code content corresponding to hash (A) of the target smart contract is the code content of logical method A of smart contract 1.

Similarly, logical method B of smart contract 2 is actually the same as logical method B of the target smart contract. Therefore, the digital digest of logical method B of smart contract 2 is definitely the same as hash (B). As such, it can be determined that the code content corresponding to hash (B) of the target smart contract is the code content of logical method B of smart contract 2.

As such, the original code of logical methods A, B, and C in the target smart contract can be restored.

Finally, the node device can assemble logical methods A, B, and C into a complete contract logical method in an instantiated virtual machine, and execute the contract logical method.

In an implementation, the method further includes the following: if execution of the target smart contract needs state data, obtaining the state data from a data field of the target smart contract; and the assembling the another logical method and the same logical method into a complete contract logical method in an instantiated virtual machine, and executing the contract logical method includes the following: assembling the another logical method and the same logical method into the complete contract logical method in the instantiated virtual machine, and loading the state data to the contract logical method for execution.

As shown in FIG. 6, assume that the node device needs to execute smart contract 1-1. The node device needs to obtain service logical method A and universal logical method A, and obtain corresponding state data from data field 1-1.

Then service logical method A and universal logical method A are assembled into a complete contract logical method in the virtual machine, and the state data is loaded to the contract logical method for execution.

It is worthwhile to note that, after executing the contract logical method, the virtual machine further needs to update a state value of the state data in the data field based on state data in an execution result, and return the execution result to a requester.

Based on the previous solution for executing a smart contract in a blockchain, in the process of executing a smart contract, the same logical method needs to be obtained based on the mapping relationship between the logical methods that are the same in the target smart contract and the stored smart contract, thereby restoring complete code of the target smart contract. In addition, due to separation of the contract logical method and the state data, each node device only needs to instantiate one virtual machine and can execute all smart contracts by using one virtual machine, thereby reducing resources needed to instantiate a virtual machine.

In conclusion, based on the solutions for storing and executing a smart contract in a blockchain provided in the present specification, the same logical method is shared so that the same logical method needs to be stored only once; and various logical methods can be mutually invoked. In addition, core data of a service, that is, state data in a data field, is isolated, encrypted, and so on. The core data is ensured, and service-related logical methods are consolidated. Universal logical methods can be invoked and published throughout the system. As such, redundancy caused when contracts have the same universal logical methods is alleviated. Various smart contracts of each node device can use the same instantiated virtual machine. Each contract interface is provided as a service method. The logical method and the state data in the blockchain system are separately stored to alleviate dependency of a smart contract on data.

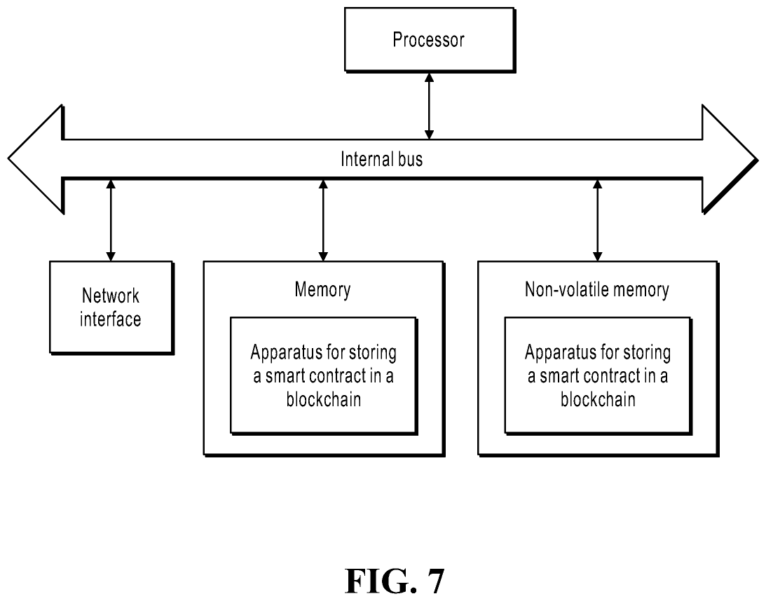

Corresponding to the previous implementation of the method for storing a smart contract in the blockchain shown in FIG. 5, the present specification further provides an implementation of an apparatus for storing a smart contract in the blockchain. The apparatus implementation can be implemented by software, or can be implemented by hardware or a combination of software and hardware. For example, the apparatus implementation is implemented by software. A logical apparatus is formed when a processor of a device where the apparatus is located reads a corresponding computer service program instruction in a non-volatile memory into the memory for running. In terms of hardware, FIG. 7 is a diagram of a hardware structure of a device in which an apparatus for storing a smart contract in the blockchain is located, according to the present specification. In addition to the processor, network interface, memory, and non-volatile memory shown in FIG. 7, the device in which the apparatus is located in the implementation generally can further include other hardware based on an actual function of storage logic of the smart contract in the blockchain. Details are omitted here for simplicity.

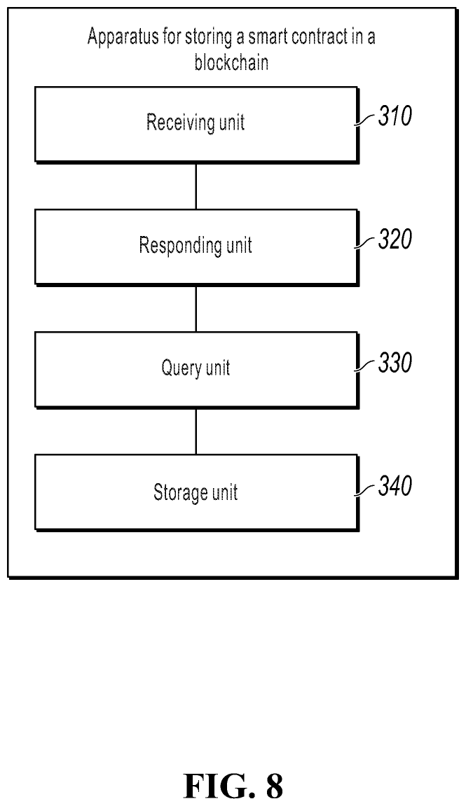

FIG. 8 is a diagram of a module of an apparatus for storing a smart contract in a blockchain, according to an implementation of the present specification. The apparatus corresponds to the implementation shown in FIG. 5. The apparatus includes the following: a receiving unit 310, configured to receive a transaction for storing a target smart contract; a responding unit 320, configured to: in response to the transaction, invoke storage logic of the smart contract published to the blockchain; a query unit 330, configured to query whether the target smart contract has a same logical method as a stored smart contract; and a storage unit 340, configured to: if yes, store, in the blockchain, another logical method except the same logical method in the target smart contract, and a mapping relationship between the logical methods that are the same in the target smart contract and the stored smart contract.

Optionally, the query unit 330 includes the following: a calculation subunit, configured to calculate a digital digest of each logical method in the target smart contract; and a determining unit, configured to: if the digital digest is consistent with a digital digest of the logical method stored in the blockchain, determine that the logical method corresponding to the consistent digital digest is the same as the logical method in the stored smart contract.

Optionally, the storage unit 340 is configured to store, in the blockchain, a mapping relationship between the logical methods that are the same in the target smart contract and the stored smart contract, including the following: converting the same logical method in the target smart contract into a digital digest of the same logical method, and storing the digital digest in the blockchain.

Optionally, the digital digest of the logical method includes the following: a hash value that is obtained through hash calculation on the logical method.

Optionally, the blockchain includes a consortium blockchain, a public blockchain, or a private blockchain.

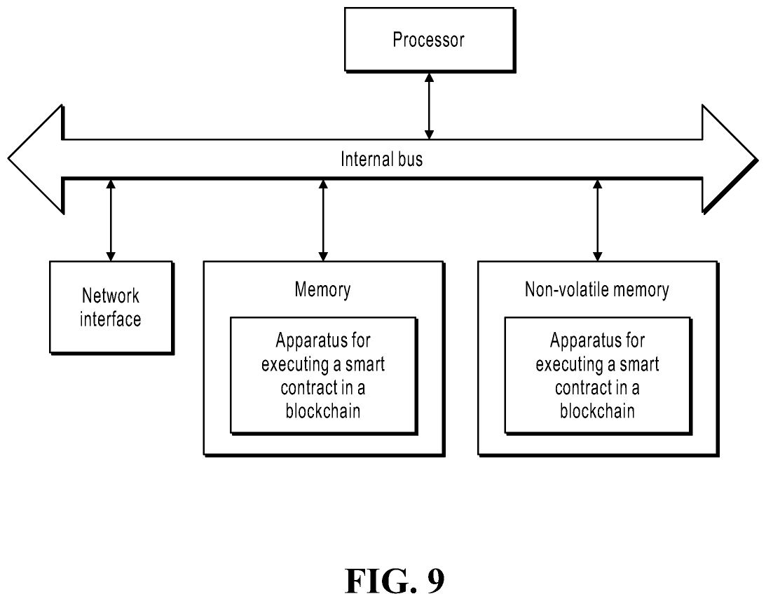

Corresponding to the previous implementation of the method for executing a smart contract in the blockchain shown in FIG. 6, the present specification further provides an implementation of an apparatus for executing a smart contract in the blockchain. The apparatus implementation can be implemented by software, or can be implemented by hardware or a combination of software and hardware. For example, the apparatus implementation is implemented by software. A logical apparatus is formed when a processor of a device where the apparatus is located reads a corresponding computer service program instruction in a non-volatile memory into the memory for running. In terms of hardware, FIG. 9 is a diagram of a hardware structure of a device in which an apparatus for executing a smart contract in the blockchain is located, according to the present specification. In addition to the processor, network interface, memory, and non-volatile memory shown in FIG. 9, the device in which the apparatus is located in the implementation generally can further include other hardware based on an actual function of execution logic of the smart contract in the blockchain. Details are omitted here for simplicity.

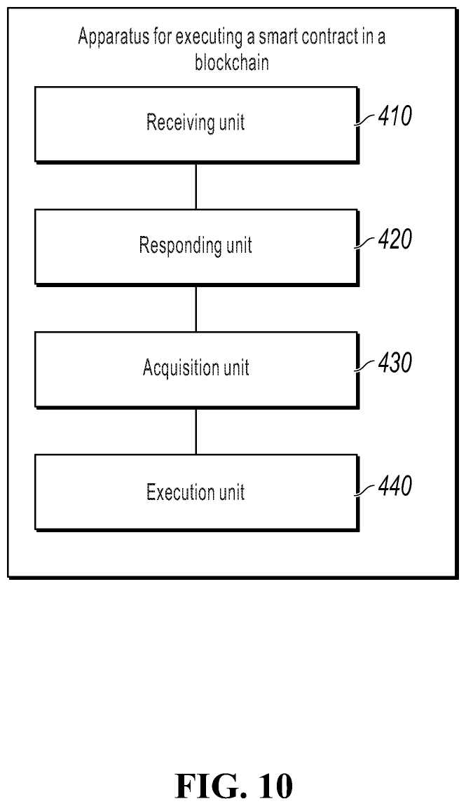

FIG. 10 is a diagram of a module of an apparatus for executing a smart contract in a blockchain, according to an implementation of the present specification. The apparatus corresponds to the implementation shown in FIG. 6. The smart contract is stored in the blockchain based on the method for storing a smart contract in a blockchain described above. The apparatus includes the following: a receiving unit 410, configured to receive a transaction for executing a target service; a responding unit 420, configured to: in response to the transaction, query a target smart contract that is needed to execute the target service in the blockchain; an acquisition unit 430, configured to obtain, based on a mapping relationship between logical methods that are the same in the target smart contract and a stored smart contract, the same logical method and another logical method except the same logical method in the target smart contract; and an execution unit 440, configured to assemble the another logical method and the same logical method into a complete contract logical method in an instantiated virtual machine, and execute the contract logical method.

Optionally, the acquisition unit 430 is configured to obtain, based on a mapping relationship between logical methods that are the same in the target smart contract and a stored smart contract, the same logical method, including the following: a first acquisition subunit, configured to obtain a digital digest stored in the target smart contract; and a second acquisition subunit, configured to: if the digital digest is the same as a digital digest of a logical method in the stored smart contract, obtain the logical method in the stored smart contract.

Optionally, the digital digest of the logical method includes the following: a hash value that is obtained through hash calculation on the logical method.

Optionally, the apparatus further includes the following: a state data acquisition subunit, configured to: if execution of the target smart contract needs state data, obtain the state data from a data field of the target smart contract; and the execution unit 440 is configured to: assemble the another logical method and the same logical method into the complete contract logical method in the instantiated virtual machine, and load the state data to the contract logical method for execution.

Optionally, the apparatus further includes the following: an instantiation unit, configured to instantiate a virtual machine when a node device in the blockchain starts, where the virtual machine is configured to execute any smart contract in the node device.

Optionally, the blockchain includes a consortium blockchain, a public blockchain, or a private blockchain.

The system, apparatus, module, or unit illustrated in the previous implementations can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

For an implementation process of functions and roles of each unit in the apparatus, references can be made to an implementation process of corresponding steps in the previous method. Details are omitted here for simplicity.

Because an apparatus implementation corresponds to a method implementation, for related parts, references can be made to related descriptions in the method implementation. The previously described apparatus implementation is merely an example. The units described as separate parts can or cannot be physically separate, and parts displayed as units can or cannot be physical units, can be located in one position, or can be distributed on multiple network units. Some or all of the modules can be selected depending on an actual demand to achieve the objectives of the solutions of the present specification. A person of ordinary skill in the art can understand and implement the implementations of the present specification without creative efforts.

FIG. 8 describes an internal functional module and a schematic structure of the apparatus for storing a smart contract in a blockchain. An execution body of the apparatus can actually be an electronic device, including the following: a processor; and a memory, configured to store a processor executable instruction, where the processor is configured to perform the following operations: receiving a transaction for storing a target smart contract; in response to the transaction, invoking storage logic of the smart contract published to the blockchain; querying whether the target smart contract has a same logical method as a stored smart contract; and if yes, storing, in the blockchain, another logical method except the same logical method in the target smart contract, and a mapping relationship between the logical methods that are the same in the target smart contract and the stored smart contract.

FIG. 10 describes an internal functional module and a schematic structure of the apparatus for executing a smart contract in a blockchain. An execution body of the apparatus can actually be an electronic device, including the following: a processor; and a memory, configured to store a processor executable instruction, where the processor is configured to perform the following operations: receiving a transaction for executing a target service; in response to the transaction, querying a target smart contract that is needed to execute the target service in the blockchain; obtaining, based on a mapping relationship between logical methods that are the same in the target smart contract and a stored smart contract, the same logical method and another logical method except the same logical method in the target smart contract; and assembling the another logical method and the same logical method into a complete contract logical method in an instantiated virtual machine, and executing the contract logical method.

The smart contract is stored in the blockchain according to any method for storing a smart contract in a blockchain described above.

In the previous implementation of the electronic device, it should be understood that the processor can be a central processing unit (CPU), or can be another general-purpose processor, a digital signal processor (DSP), an application-specific integrated circuit (ASIC), etc. The general-purpose processor can be a microprocessor, the processor can be any conventional processor, etc. The previous memory can be a read-only memory (ROM), a random access memory (RAM), a flash memory, a hard disk, or a solid-state disk. The steps of the methods disclosed in the implementations of the present disclosure can be directly performed by a hardware processor, or performed by a combination of hardware and software modules in a processor.

The implementations in the present specification are described in a progressive way. For same or similar parts of the implementations, references can be made to the implementations mutually. Each implementation focuses on a difference from other implementations. Particularly, an electronic device implementation is similar to a method implementation, and therefore is described briefly. For related parts, references can be made to related descriptions in the method implementation.

A person skilled in the art can easily figure out another implementation of the present specification after thinking over the specification and practicing the present disclosure here. The present specification is intended to cover any variations, uses, or adaptations of the present specification, and these variations, uses, or adaptations follow the general principles of the present specification and include common knowledge or conventional techniques that are not disclosed in the technical field of the present specification. The specification and the implementations are merely considered as examples, and the actual scope and the spirit of the present specification are pointed out by the following claims.

It should be understood that the present specification is not limited to the precise structures that have been described above and shown in the drawings, and various modifications and changes can be made without departing from the scope of the present specification. The scope of the present specification is limited by the appended claims only.

What is claimed is:

1. A computer-implemented method for storing a smart contract in a blockchain, method comprising:
receiving a first transaction request to conduct a first transaction for storing a first target smart contract in the blockchain, wherein the first target smart contract comprises a plurality of logical methods;
in response to receiving the first transaction request, invoking storage logic of the first target smart contract;
querying whether the first target smart contract comprises a first logical method that is the same as a second logical method in a first stored smart contract that is stored in the blockchain; and
in response to determining that the first target smart contract comprises the first logical method that is the same as the second logical method in the first stored smart contract,
storing, in the blockchain, each logical method of the plurality of logical methods that is not the same as a logical method previously stored in the blockchain, and
storing a first mapping relationship between the first logical method in the first target smart contract and the second logical method in the first stored smart contract.

2. The computer-implemented method of claim 1, wherein querying whether the first target smart contract comprises the first logical method that is the same as the second logical method comprises:
calculating a unique identifier for each logical method in the plurality of logical methods; and
determining, for each logical method in the plurality of logical methods, whether the unique identifier for the logical method is consistent with a unique identifier of a stored logical method previously stored in the blockchain; and
in response to determining that a first unique identifier calculated for the first logical method is consistent with a second unique identifier calculated for the second logical method, determining that the first logical method is the same as the second logical method.

3. The computer-implemented method of claim 2, wherein the unique identifier for each logical method comprises a unique path comprising a file name and a method name of the logical method.

4. The computer-implemented method of claim 2, wherein the unique identifier for each logical method comprises a digital digest comprising a hash value that is obtained through hash calculation on the logical method.

5. The computer-implemented method of claim 1, wherein storing, in the blockchain, the first mapping relationship between the first logical method in the first target smart contract and the second logical method in the first stored smart contract comprises:
converting the first logical method in the first target smart contract into a unique identifier of the first logical method, and storing the unique identifier in the blockchain.

6. The computer-implemented method of claim 1, wherein the blockchain comprises a consortium blockchain, a public blockchain, or a private blockchain.

7. The computer-implemented method of claim 1, further comprising:
receiving a second transaction request for conducting a second transaction for executing a target service;
in response to receiving the second transaction request, querying a second target smart contract, wherein the second target smart contract executes the target service in the blockchain;
obtaining, based on a second mapping relationship between a third logical method in the second target smart contract and a fourth logical method in a second stored smart contract, the fourth logical method from the second stored smart contract and an additional logical method from the second target smart contract, wherein the second mapping relationship indicates that the third logical method is the same as the fourth logical method; and
assembling the additional logical method and the fourth logical method into a complete contract logical method in an instantiated virtual machine; and
executing the complete contract logical method,
wherein the first stored smart contract is the same as or different from the second stored smart contract.

8. The computer-implemented method of claim 7, wherein obtaining, based on the second mapping relationship, the fourth logical method and the additional logical method comprises:
obtaining a unique identifier stored in the second target smart contract;
determining that the unique identifier stored in the second target smart contract is consistent with an additional unique identifier for the fourth logical method in the second stored smart contract; and
in response to determining that the unique identifier stored in the second target smart contract is consistent with the additional unique identifier for the fourth logical method, obtaining the fourth logical method.

9. The computer-implemented method of claim 7, further comprising, obtaining state data from a data field of the second target smart contract,
wherein executing the complete contract logical method comprises loading the state data to the complete contract logical method for execution.

10. The computer-implemented method of claim 7, further comprising instantiating a virtual machine when a node device in the blockchain starts running, wherein the virtual machine is configured to execute any smart contract in the node device.

11. A non-transitory, computer-readable medium storing one or more instructions executable by a computer system to perform operations comprising:
receiving a first transaction request to conduct a first transaction for storing a first target smart contract in a blockchain, wherein the first target smart contract comprises a plurality of logical methods;
in response to receiving the first transaction request, invoking storage logic of the first target smart contract;
querying whether the first target smart contract comprises a first logical method that is the same as a second logical method in a first stored smart contract that is stored in the blockchain; and
in response to determining that the first target smart contract comprises the first logical method that is the same as the second logical method in the first stored smart contract,
storing, in the blockchain, each logical method of the plurality of logical methods that is not the same as a logical method previously stored in the blockchain, and
storing a first mapping relationship between the first logical method in the first target smart contract and the second logical method in the first stored smart contract.

12. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving a first transaction request to conduct a first transaction for storing a first target smart contract in a blockchain, wherein the first target smart contract comprises a plurality of logical methods;
in response to receiving the first transaction request, invoking storage logic of the first target smart contract;
querying whether the first target smart contract comprises a first logical method that is the same as a second logical method in a first stored smart contract that is stored in the blockchain; and
in response to determining that the first target smart contract comprises the first logical method that is the same as the second logical method in the first stored smart contract,
storing, in the blockchain, each logical method of the plurality of logical methods that is not the same as a logical method previously stored in the blockchain, and
storing a first mapping relationship between the first logical method in the first target smart contract and the second logical method in the first stored smart contract.

13. The computer-implemented system of claim 12, wherein querying whether the first target smart contract comprises the first logical method that is the same as the second logical method comprises:
calculating a unique identifier for each logical method in the plurality of logical methods; and
determining, for each logical method in the plurality of logical methods, whether the unique identifier for the logical method is consistent with a unique identifier of a stored logical method previously stored in the blockchain; and
in response to determining that a first unique identifier calculated for the first logical method is consistent with a second unique identifier calculated for the second logical method, determining that the first logical method is the same as the second logical method.

14. The computer-implemented system of claim 13, wherein the unique identifier for each logical method comprises a unique path comprising a file name and a method name of the logical method.

15. The computer-implemented system of claim 13, wherein the unique identifier for each logical method comprises a digital digest comprising a hash value that is obtained through hash calculation on the logical method.

16. The computer-implemented system of claim 12, wherein storing, in the blockchain, the first mapping relationship between the first logical method in the first target smart contract and the second logical method in the first stored smart contract comprises:
converting the first logical method in the first target smart contract into a unique identifier of the first logical method, and storing the unique identifier in the blockchain.

17. The computer-implemented system of claim 12, wherein the blockchain comprises a consortium blockchain, a public blockchain, or a private blockchain.

18. The computer-implemented system of claim 12, wherein the operations comprise:
receiving a second transaction request for conducting a second transaction for executing a target service;
in response to receiving the second transaction request, querying a second target smart contract, wherein the second target smart contract executes the target service in the blockchain;
obtaining, based on a second mapping relationship between a third logical method in the second target smart contract and a fourth logical method in a second stored smart contract, the fourth logical method from the second stored smart contract and an additional logical method from the second target smart contract, wherein the second mapping relationship indicates that the third logical method is the same as the fourth logical method; and
assembling the additional logical method and the fourth logical method into a complete contract logical method in an instantiated virtual machine; and
executing the complete contract logical method,
wherein the first stored smart contract is the same as or different from the second stored smart contract.

19. The computer-implemented system of claim 18, wherein obtaining, based on the second mapping relationship, the fourth logical method and the additional logical method comprises:
obtaining a unique identifier stored in the second target smart contract;
determining that the unique identifier stored in the second target smart contract is consistent with an additional unique identifier for the fourth logical method in the second stored smart contract; and
in response to determining that the unique identifier stored in the second target smart contract is consistent with the additional unique identifier for the fourth logical method, obtaining the fourth logical method.

20. The computer-implemented system of claim 18, wherein the operations comprise obtaining state data from a data field of the second target smart contract,
wherein executing the complete contract logical method comprises loading the state data to the complete contract logical method for execution.
